(19) United States
(12) Patent Application Publication
(10) Pub. No.: US 2007/0045160 A1
(43) Pub. Date: Mar. 1, 2007

(54) Flow directing and monitoring apparatus for use with filter system

(76) Inventors: Russell E. Prescott, Kingston, NH (US); Perrin T. Prescott, Exeter, NH (US)

Correspondence Address: Kevin J. Carroll, Esquire;GROSSMAN, TUCKER, PERREAULT & PFLEGER, PLLC, 55 South Commercial Street, Manchester, NH, 03101, US

(21) Appl. No.: 11/211,415

(22) Filed: Aug. 25, 2005

(51) Int. Cl. B01D 35/14

(52) U.S. Cl. 210/87; 210/90; 210/341; 137/552; 137/551; 137/557

(57) ABSTRACT

A filter system may be used to filter water to remove or reduce levels of contaminants, such as arsenic. The filter system may include a flow directing and monitoring apparatus that directs the flow of water into and out of the filter system and monitors the flow (e.g., the pressure, the flow rate, the flow volume, and the peak flow).

### TECHNICAL FIELD

The present invention relates to filter systems and more particularly, to a flow directing and monitoring apparatus for use with an arsenic removal system.

### BACKGROUND INFORMATION

Filter systems may be used to remove contaminants from drinking water. One type of contaminant that may occur naturally in drinking water is arsenic. Severe health effects have been observed in individuals who have consumed arsenic-rich water over long periods of time. Arsenic contamination is especially a concern in residential well-water systems. As a result, filter systems have been developed to remove or reduce arsenic in drinking water to an acceptable level. The U.S. Environmental Protection Agency will be reducing the Maximum Contaminant Level (MCL) for arsenic to 0.01 mg/L.

An estimated 10-15 million residences in the United States have arsenic levels greater than 0.01 mg/L. Field trial testing of arsenic treatment materials has been conducted to determine the Best Available Technology (BAT), which has the greatest capacity to remove arsenic for the least initial and long term cost. To determine the greatest capacity to remove arsenic, water may be run through the arsenic treatment materials (e.g., minerals) to just before arsenic breakthrough above the MCL. The testing has been conducted by scientists using laboratory-style custom installations. The installations have included piping, valves, fittings, mineral tanks, sample taps, pressure gauges, flow controls, and monitoring devices to determine flow, peak flow and total gallons.

Such testing procedures and installations may not be suitable for residential arsenic removal applications. In a residential application, for example, it is generally not desirable to allow water to run through arsenic treatment materials until just prior to breakthrough above the MCL. In the event that the arsenic breaks through, users may inadvertently consume water with unacceptable levels of arsenic contamination. To prevent this, a residential arsenic removal application should assure that the treatment materials are replaced before the arsenic breakthrough occurs. In one example, two treatment systems may be used. After a first treatment system is consumed, a second or backup system may continue to provide adequate arsenic removal until the first treatment system is replaced.

One type of filter system may include one or more filter tanks including a filter medium (e.g., arsenic treatment materials). The filter tank(s) may be connected to an existing water supply such that water flows into the tank(s), is filtered by the filter medium and then flows out of the tank(s). To connect such systems, pipes and valves often must be coupled together to direct water into the filter tank(s). Flow monitoring equipment, such as pressure gauges and/or flow sensors, may be connected to the pipes to monitor the flow of water into and out of the filter system to assure proper functioning and filtering. Plumbing the pipes, valves and flow monitoring equipment into an existing water supply system may be tedious and time consuming.

Accordingly, there is a need for a flow directing and monitoring apparatus that facilitates the incorporation of a filter system into an existing water supply system.

### BRIEF DESCRIPTION OF THE DRAWINGS

These and other features and advantages will be better understood by reading the following detailed description, taken together with the drawings wherein:

FIG. 1 is a front view of a filter system, consistent with one embodiment of the present invention.

FIG. 2 is a top view of one embodiment of a flow directing and monitoring apparatus with an open housing, which may be used in the filter system shown in FIG. 1.

FIG. 3 is a top view of the flow directing and monitoring apparatus shown in FIG. 2 with a closed housing.

FIG. 4 is a bottom view of the flow directing and monitoring apparatus shown in FIG. 2.

FIG. 5 is a front view of the flow directing and monitoring apparatus shown in FIG. 2.

FIG. 6 is a diagrammatic view illustrating the operation of the flow directing and monitoring apparatus shown in FIG. 2.

### DETAILED DESCRIPTION

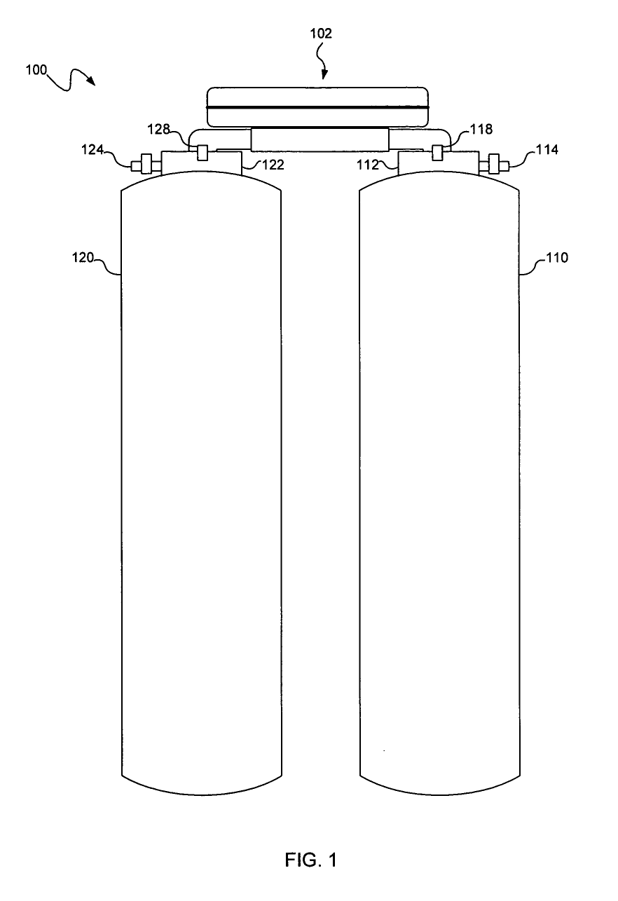

Referring to FIG. 1, one embodiment of a filter system 100 including a flow directing and monitoring apparatus 102 is described. In an exemplary embodiment, the filter system 100 may be used to remove or reduce arsenic levels in drinking water. The flow directing and monitoring apparatus 102 may also be used with other types of filter systems or water treatment systems. The flow directing and monitoring apparatus 102 directs the flow of water into and out of the filter system 100 and monitors flow characteristics (e.g., the pressure, the flow rate, the flow volume, and the peak flow). The flow directing and monitoring apparatus 102 of the filter system 100 may be coupled to a residential water system, for example, at the point of entry. Although the filter system 100 is designed for a residential water supply system, the filter system 100 and/or the flow directing and monitoring apparatus 102 may also be used in a commercial water supply system.

One embodiment of the filter system 100 includes first and second filter tanks 110, 120. Each of the filter tanks 110, 120 may have a structure known to those skilled in the art and may include a filter medium that removes or reduces the level of contaminants in the water as the water flows through the medium. In an arsenic removal system, for example, the filter medium may include a hybrid ion exchange resin such as the type available under the name ArsenXnp™ from SolmeteX Inc. and Purolite Inc. Although the exemplary embodiment includes two filter tanks 110, 120, the filter system 100 may include only a single tank or more than two tanks.

Each of the filter tanks 110, 120 may include a tank head 112, 122 at the top of the respective tank 110, 120. The flow directing and monitoring apparatus 102 may be coupled to the tank heads 112, 122 of the filter tanks 110, 120 such that water passes through the apparatus 102, into the filter tanks 110, 120, out of the filter tanks 110, 120, and back through the apparatus 102. One or more sample taps 114, 124 may be coupled to the tank heads 112, 122 to allow water to be tapped or removed as the water flows into and out of the filter tanks 110, 120. The sample taps 114, 124 may also be coupled to other locations on the tanks 110, 120 or on the flow directing and monitoring apparatus 102. One or more fastening clips 118, 128 or other similar fasteners may be used to mechanically secure the flow directing and monitoring apparatus 102 to the tank heads 112, 122 of the tanks 110, 120.

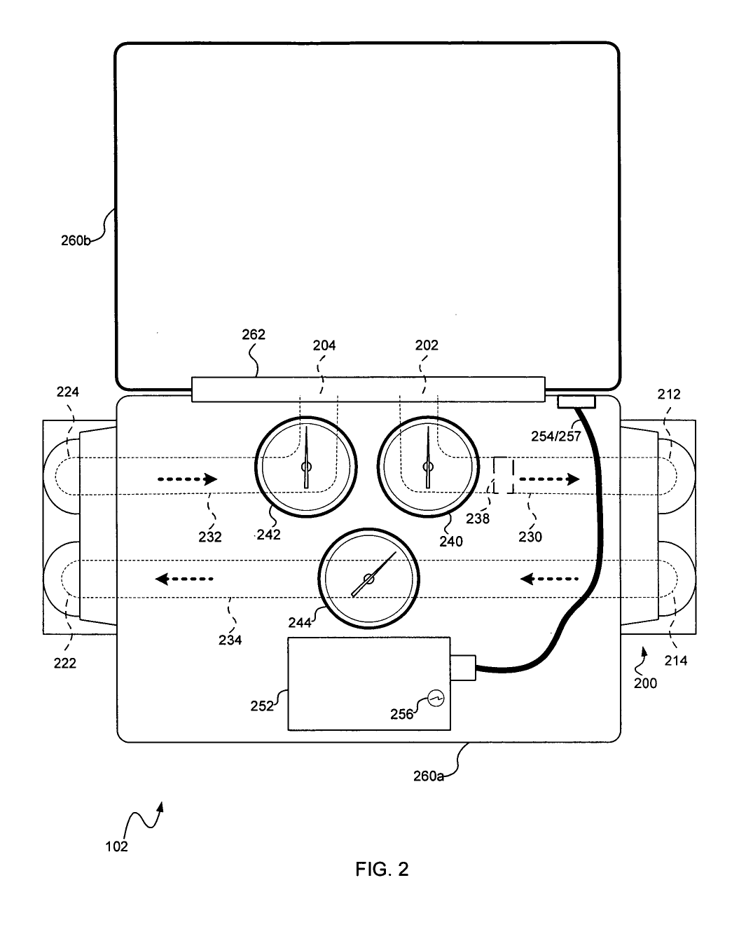

Referring to FIGS. 2-5, one embodiment of the flow directing and monitoring apparatus 102 is described in greater detail. The flow directing and monitoring apparatus 102 may include a manifold assembly 200 including inlets, outlets and passageways that direct water through the apparatus 102 and into and out of the filter tanks 110, 120. In particular, the manifold assembly 200 may include a main inlet 202 allowing water to flow in from a water supply line (not shown) and a main outlet 204 allowing water to flow out to a water delivery line (not shown).

The manifold assembly 200 may also include inlets and outlets that are configured to be coupled to the first and second tanks 110, 120 (shown in FIG. 1). On a first side of the manifold assembly 200, for example, a first side outlet 212 allows water to flow out to the first tank 110 and a first side inlet 214 allows water to flow in from the first tank 110. On a second side of the manifold assembly 200, a second side outlet 222 allows water to flow out to the second tank 120 and a second side inlet 224 allows water to flow in from the second tank 120.

The manifold assembly 200 may also include an inlet passageway 230, an outlet passageway 232 and an intermediate passageway 234 extending between the inlets and outlets to allow water to pass through. The inlet passageway 230 extends from the main inlet 202 to the first side outlet 212. The outlet passageway 232 extends from the second side inlet 224 to the main outlet 204. The intermediate passageway 234 extends from the first side inlet 214 to the second side outlet 222. The passageways 230, 232, 234 may have a diameter of about 1/2 in. or greater. The manifold assembly 200 may include a flow control device 238 located in the inlet passageway 230, for example, to control the flow of water through the inlet passageway 230 and into the first tank 110. One embodiment of the flow control device 238 may provide for an adjustable flow control. One example of a flow control device may include a flow control button such as the 6 GPM flow washer available under Fleck P/N 17814 and a retainer such as the flow washer retainer available under Fleck P/N 13173.

The flow directing and monitoring apparatus 102 may also include flow monitoring equipment for monitoring flow through the manifold assembly. For example, the flow directing and monitoring apparatus 102 may include one or more pressure gauges 240, 242, 244 coupled to the passageways 230, 232, 234, respectively, to monitor water pressure in the passageways 230, 232, 234. An inlet pressure gauge 240 is coupled to the inlet passageway 230 and is responsive to pressure changes in the inlet passageway 230. An outlet pressure gauge 242 is coupled to the outlet passageway 232 and is responsive to pressure changes in the outlet passageway 232. An intermediate pressure gauge 244 is coupled to the intermediate passageway 234 and is responsive to pressure changes in the intermediate passageway 234. The pressure gauges 240, 242, 244 may include any type of pressure gauge known to those skilled in the art.

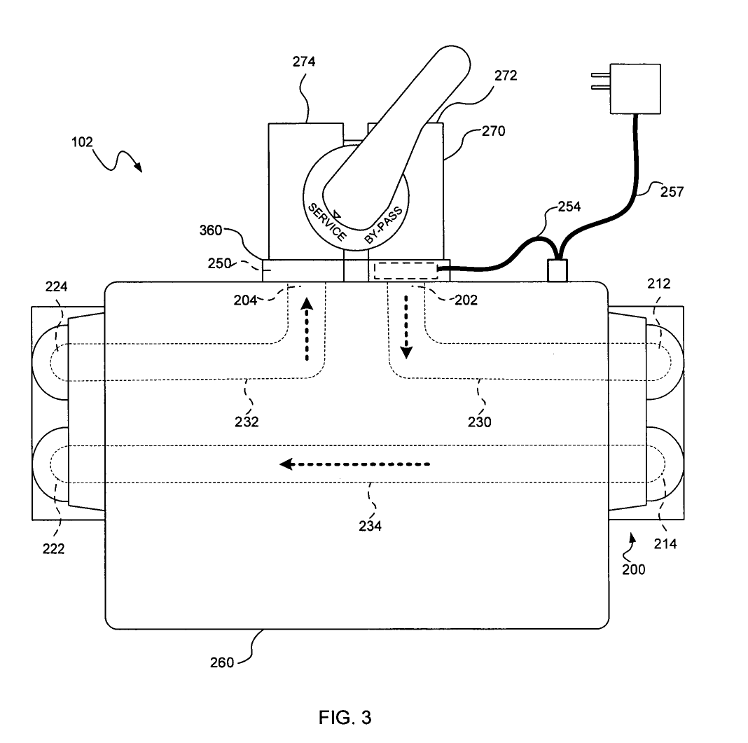

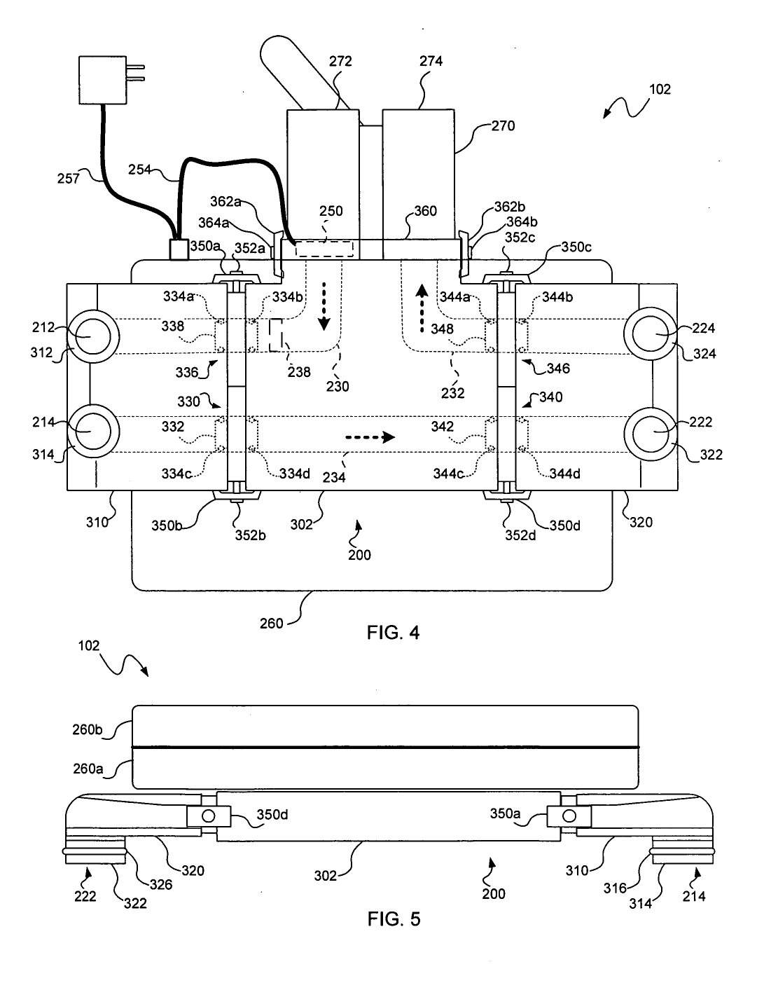

The flow directing and monitoring apparatus 102 may further include a flow meter or sensor 250 (see FIGS. 3 and 4) to sense flow through of the manifold assembly 200 and a flow monitor 252 coupled to the flow sensor 250 to monitor flow characteristics such as flow volume and rate (see FIG. 2). The flow sensor 250 may be located at any point in the flow path through the manifold assembly 200. In one embodiment, the flow sensor 250 is coupled to the inlet passageway 230, although the flow sensor 250 may also be coupled to the outlet passageway 232 or the intermediate passageway 234. The flow sensor 250 may include a Hall effect sensor or other sensor known to those skilled in the art for sensing the flow of a fluid and generating a signal representing the flow of the fluid.

The flow monitor 252 may include circuitry (e.g., on a circuit board) that receives flow sensor signals from the flow sensor 250 and calculates the flow characteristics such as flow volume, flow rate and/or peak flow. The flow monitor 252 may also include one or more indicators 256 to provide an indication of flow characteristics, as will be described in greater detail below. The indicator 256 may be a visual indicator such as a LED or an audible indicator such as an alarm. The flow monitor 252 may also include one or more controls (not shown) to control to control settings on the flow monitor 252, for example, to set a predetermined flow characteristic value or to reset a flow characteristic being monitored. The flow sensor 252 may be coupled to the flow monitor 252 using a cable 254. A power cable 257 may also be coupled to the monitor 252 for connecting to a power source 258 (shown in FIG. 6).

The flow directing and monitoring apparatus 102 may also include a housing 260 enclosing the pressure gauges 240, 242, 244 and the flow monitor 252. One embodiment of the housing 260 includes two housing portions 260a, 260b coupled together with a hinge 262 (see FIG. 2). The housing 260 may be made of any suitable material including, but not limited to, stainless steel. The cable 254 coupling the flow sensor 250 to the flow monitor 252 and the power cable 257 may pass through the housing 260. In an alternative embodiment, sample taps may also be located inside of the housing 260 and may be coupled to the respective passageways 230, 232, 234 (i.e., instead of taps 114, 124 on tank heads 112, 122).

The flow directing and monitoring apparatus 102 may further include a by-pass valve 270 coupled to the manifold assembly 200. The by-pass valve 270 may have a structure known to those skilled in the art and generally includes a valve inlet 272 and a valve outlet 274. The by-pass valve 270 may be coupled to the water supply line and water delivery line in a residential water system. In a first position (i.e., in service), the by-pass valve 270 allows water to flow through the valve 270 and into the manifold assembly 200. In a second position (i.e., by-pass), the by-pass valve 270 causes water to flow from the valve inlet 272 to the valve outlet 274 and prevents water from flowing into the manifold assembly 200, thereby by-passing the flow directing and monitoring apparatus 102 and the filter system 100.

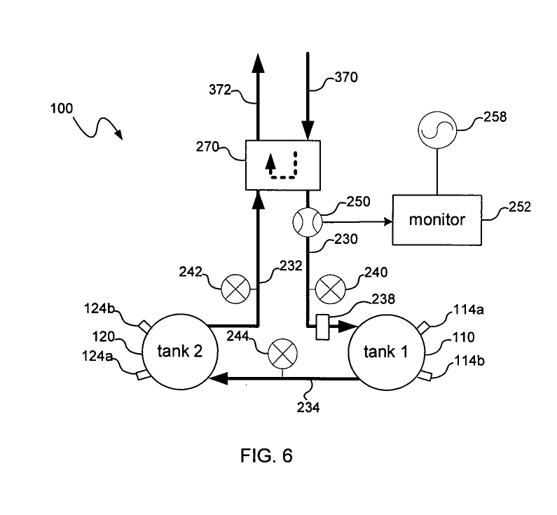

According to one embodiment of the flow directing and monitoring apparatus 102, the manifold assembly 200 may include multiple pieces (see FIGS. 4 and 5). The manifold assembly 200 may include a manifold block 302 and first and second tank adapters 310, 320 coupled to the manifold block 302. The manifold block 302 may be made of PVC or another suitable material and may include the passageways 230, 232, 234 formed therein. The housing 260 may be secured to a top side of the manifold block 302, for example, using screws. The pressure gauges 240, 242, 244 may be threadably tapped into the manifold block 302 (e.g., through the housing 260) such that the pressure gauges are coupled to the respective passageways 230, 232, 234.

The tank adapters 310, 320 may include tank engaging portions 312, 314, 322, 324 that are configured to extend into openings in the filter tanks 110, 120 (see FIG. 1) to fluidly connect the manifold assembly 200 to the tanks 110, 120. The first tank adapter 310 includes a tank engaging portion 312 that defines the first side outlet 212 and a tank engaging portion 314 that defines the first side inlet 214. The second tank adapter 320 includes a tank engaging portion 322 that defines the second side outlet 222 and a tank engaging portion 324 that defines the second side inlet 224. O-rings 316, 326 (see FIG. 5) may be positioned around each of the tank engaging portions 312, 314, 322, 324 to seal against the respective openings in the tank heads 112, 122. The tank adapters 310, 320 may be made of a carbon fiber composite or another suitable material.

Couplers 330, 336, 340, 346 may be positioned between each of the tank adapters 310, 320 and the manifold block 302 to fluidly couple the tank adapters 310, 320, respectively, to the manifold block 302. The couplers 330, 336, 340, 346 may include portions 332, 338, 342, 348 that extend into the respective passageways 230, 232, 234. One example of the couplers 330, 340 include the adapter couplings available under Fleck P/N 19228. O-rings 334a-334d, 344a-344d may be positioned around each of the respective coupler portions 332, 338, 342, 348 to seal against the inner surfaces of the passageways 230, 232, 234. One example of the O-rings include adapter coupler O-rings available under Fleck P/N 13305. One or more fastening clips 350a-350d with screws 352-350d or other type of fastener may be used to mechanically secure the tank adapters 310, 320 to the manifold block 302 with the couplers 330, 340 sandwiched in between. One example of the clips and screws include the adapter coupling clips and screws available under Fleck P/N 13255 and P/N 13314.

A coupler 360 may also be used to couple the by-pass valve 270 to the manifold assembly 200 (e.g., to the manifold block 302). In one embodiment, the flow sensor 250 may be located in the coupler 360 on the side that is coupled to the main inlet 202. One or more fastening clips 362a, 362b with screws 364a, 364b or other fasteners may be used to mechanically secure the by-pass valve 270 to the manifold block 302 with the coupler 360 sandwiched in between.

Although the exemplary embodiment of the manifold assembly 200 includes multiple pieces, the manifold assembly 200 may also be formed as a single piece. Those skilled in the art will also recognize that other shapes and configurations may be used for the manifold assembly 200.

Referring to FIG. 6, the operation of the filter system 100 including the flow directing and monitoring apparatus is described in greater detail. When the by-pass valve 270 is in the by-pass position, water from a supply line 370 is directed by the by-pass valve 270 directly to a delivery line 372. When the by-pass valve 270 is in the service position, water from the supply line 370 is allowed to pass through the by-pass valve 270 and into the inlet passageway 230. The water passes through the inlet passageway 230, through the flow control device 238, and into the first filter tank 110 where the water is filtered by the filter medium. The inlet gauge 240 responds to the inlet pressure in the inlet passageway 230 and displays the associated pressure. Water may be removed prior to entering the first tank 110 using a first side inlet sample tap 114a.

After filtering through the first tank 110, the water passes through the intermediate passageway 234 and into the second tank 120. Water may be removed after filtering in the first tank 110 using either a first side outlet sample tap 114b or a second side inlet sample tap 124a. The intermediate gauge 244 responds to a pressure in the intermediate passageway 234 and displays the associated pressure. After filtering through the second tank 120, the water passes through the outlet passageway 232 to the by-pass valve 270. The outlet gauge 242 responds to a pressure in the outlet passageway 232 and displays the associated pressure. Water may be removed after filtering in the second tank 120 using the second side outlet sample tap 124b. The water removed from the sample taps 114a, 114b, 124a, 124b may be tested to determine the level of contaminants (e.g. arsenic) at various points in the filter system. The level of contaminants in the water removed after one or both filter tanks 110, 120, for example, may be used to determine the effectiveness of the filter tank(s) and/or to determine if one or more of the tanks should be replaced.

The flow sensor 250 senses the flow of water through the manifold assembly 200 (e.g., into the inlet passageway 230) and generates flow sensor signals representing the flow. The flow monitor 252 receives the flow sensor signals and calculates the flow characteristics such as flow volume, flow rate and/or peak flow. The flow monitor 252 may compare the calculated or monitored flow characteristic value(s) with a predetermined flow characteristic value(s). If a predetermined value is reached, the flow monitor 252 may provide an indication, for example, by activating a visual or audible alarm.

In one embodiment, a predetermined volume may be determined according to the volume of water and arsenic concentration that is filtered before replacing a tank. By comparing a calculated or monitored flow volume with this predetermined “replacement” volume, the flow monitor 252 may thus provide an indication of when the tank should be replaced.

Thus, the sample taps may be used to monitor the arsenic concentrations at the main inlet, the outlet of the first tank, and the main outlet to determine arsenic breakthrough. When breakthrough is determined for the first tank, the water may be filtered through the second tank before replacing the first tank. The greatest capacity may therefore be recorded for the first tank before it is replaced. By monitoring volume, the “total gallons” corresponding to this greatest capacity may be used to set the flow monitor to provide an indication of when the next tank should be replaced.

In summary, a flow directing and monitoring apparatus may be used to direct flow of water to a filter system and to monitor the flow of water. The flow directing and monitoring apparatus may be advantageously provided as an integrated unit, which facilitates the installation of the filter system with a single point plumbing connection in and out.

Consistent with one embodiment, a flow directing and monitoring apparatus may include a manifold assembly including a main inlet, a main outlet, a first side inlet, a first side inlet, a second side outlet, a second side inlet, an inlet passageway from the main inlet to the first side inlet, an intermediate passageway from the first side inlet to the second side outlet, and an outlet passageway from the second side inlet to the main outlet. The flow directing apparatus may also include at least one pressure gauge coupled to at least one of the inlet passageway, the outlet passageway, and the intermediate passageway.

Consistent with another embodiment, a filter system may include first and second filter tanks each including a filtering medium and a flow directing and monitoring apparatus removably coupled to the filter tanks.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A flow directing and monitoring apparatus comprising:
a manifold assembly including a main inlet, a main outlet, a first side outlet, a first side inlet, a second side outlet, a second side inlet, an inlet passageway from said main inlet to said first side outlet, an intermediate passageway from said first side inlet to said second side outlet, and an outlet passageway from said second side inlet to said main outlet; and
at least one pressure gauge coupled to at least one of said inlet passageway, said outlet passageway and said intermediate passageway.

2. The flow directing and monitoring apparatus of claim 1 wherein said at least one pressure gauge comprises an inlet pressure gauge coupled to said inlet passageway, an outlet pressure gauge coupled to said outlet passageway, and an intermediate pressure gauge coupled to said intermediate passageway.

3. The flow directing and monitoring apparatus of claim 1 further comprising a flow sensor coupled to a flow path through said manifold assembly.

4. The flow directing and monitoring apparatus of claim 3 wherein said flow sensor is coupled to said inlet passageway.

5. The flow directing and monitoring apparatus of claim 3 further comprising a flow monitor coupled to said flow sensor, said flow monitor being configured to monitor at least a flow volume.

6. The flow directing and monitoring apparatus of claim 5 wherein said flow monitor is configured to compare said monitored flow volume to a predetermined flow volume.

7. The flow directing and monitoring apparatus of claim 6 wherein said flow monitor includes an indicator configured to provide an indication of when said monitored flow volume reaches said predetermined flow volume.

8. The flow directing and monitoring apparatus of claim 5 further comprising a housing coupled to said manifold assembly, said housing enclosing said at least one pressure gauge and said flow monitor.

9. The flow directing and monitoring apparatus of claim 2 further comprising a housing coupled to said manifold assembly, said housing enclosing said inlet pressure gauge, said outlet pressure gauge, said intermediate pressure gauge.

10. The flow directing and monitoring apparatus of claim 1 further comprising a by-pass valve coupled to said main inlet and said main outlet, said by-pass valve being operable to by-pass flow through said flow directing and monitoring apparatus.

11. The flow directing and monitoring apparatus of claim 1 wherein said manifold assembly comprises a manifold block and first and second tank adapters coupled to said manifold block.

12. A flow directing and monitoring apparatus comprising:
a manifold assembly including a main inlet, a main outlet, a first side outlet, a first side inlet, a second side outlet, a second side inlet, an inlet passageway from said main inlet to said first side outlet, an intermediate passageway from said first side inlet to said second side outlet, and an outlet passageway from said second side inlet to said main outlet;
flow monitoring equipment configured to monitor flow through said manifold assembly; and
a housing coupled to said manifold assembly, said housing enclosing said flow monitoring equipment coupled to at least one of said passageways.

13. The flow directing and monitoring apparatus of claim 12 wherein said flow monitoring equipment includes at least one pressure gauge coupled to at least one of said passageways to monitor pressure and a flow monitor configured to monitor at least a flow volume through said manifold assembly.

14. A filter system comprising:
first and second filter tanks, each of said tanks including a filtering medium; and
a flow directing and monitoring apparatus removably coupled to said filter tanks, said flow directing and monitoring apparatus comprising:
a manifold assembly comprising a main inlet, a main outlet, a first side inlet, a first side outlet, a second side outlet, a second side inlet, an inlet passageway from said main inlet to said first side outlet, an intermediate passageway from said first side inlet to said second side outlet, and an outlet passageway from said second side inlet to said main outlet.

15. The filter system of claim 14 wherein said flow directing and monitoring apparatus further comprises:
an inlet pressure gauge coupled to said inlet passageway;
an outlet pressure gauge coupled to said outlet passageway; and
an intermediate pressure gauge coupled to said intermediate passageway.

16. The filter system of claim 14 a flow sensor coupled to a flow path through said manifold assembly.

17. The filter system of claim 16 further comprising a flow monitor coupled to said flow sensor, said flow monitor being configured to monitor at least a flow volume.

18. The filter system of claim 17 wherein said flow monitor is configured to compare said monitored flow volume to a predetermined flow volume.

19. The filter system of claim 18 wherein said predetermined flow volume corresponds to replacement of at least one of said tanks.

20. The filter system of claim 19 wherein said flow monitor includes an indicator configured to provide an indication corresponding to replacement of at least one of said tanks.

21. The filter system of claim 15 further comprising a housing coupled to said manifold assembly, said housing enclosing said inlet pressure gauge, said outlet pressure gauge and said intermediate pressure gauge.

22. The filter system of claim 14 further comprising a by-pass valve coupled to said main inlet and said main outlet, said by-pass valve being operable to by-pass flow through said flow directing and monitoring apparatus.

23. The filter system of claim 14 wherein said flow directing and monitoring apparatus further comprises:
an inlet sample tap coupled to said inlet passageway;
an outlet sample tap coupled to said outlet passageway; and
an intermediate sample tap coupled to said intermediate passageway.
